(19) United States
(12) Patent Application Publication
(10) Pub. No.: US 2021/0295244 A1
(43) Pub. Date: Sep. 23, 2021

(54) PRODUCT METADATA MANAGEMENT

(71) Applicant: AMain.com,Inc., Chico, CA (US)

(72) Inventor: Kendall John Bennett, Chico, CA (US)

(73) Assignee: AMain.com,Inc., Chico, CA (US)

(21) Appl. No.: 16/826,960

(22) Filed: Mar. 23, 2020

(51) Int. Cl. G06Q 10/08; G06Q 30/06; G06K 7/14; G06K 7/10; G06F 16/23; G06F 3/0484

(52) U.S. Cl. CPC G06Q 10/087; G06Q 30/0627; G06Q 30/0641; G06F 3/0482; G06K 7/10722; G06F 16/23; G06F 3/04847; G06K 7/1413

(57) ABSTRACT

A computer-implemented system and method of improving product metadata is provided. The method includes storing a plurality of datasets associated with a plurality of items in a database by a server. Each dataset is associated with an item and item metadata and include at least one of an attribute, an item name, a bar code and an item image. The server may present a graphical user interface (GUI) on a user device. The GUI comprises a search box and a set of attribute-based filters. The set of attribute-based filters includes a negative filter and a positive filter. The server receives a search request with a user input and a selection of the negative filter associated with a predefined attribute. The server may apply the negative filter to search the database to present a list of items each without the predefined attribute on the user device based on the search request.

### TECHNICAL FIELD

The present disclosure relates to product metadata management, and more specifically to applying attribute-based filters to improve product metadata in an information management environment.

### BACKGROUND

A commercial website may display products and associated information based on the stored product metadata and images. Product metadata may be related to a plurality of item attributes such as color, size, manufacturer, etc. When customers are searching on an ecommerce web site, they normally select one or more available attribute-based filters (e.g., facet-based filters) to limit search results to show products with particular attributes associated with corresponding product metadata. When rendering search results, existing search engines may render available filters on the web pages, which allow customers to refine the search results by different attributes or facets. The way filtering currently works is that a user may choose to filter on specific filters/facets such that all matched items are included in the search results, and all those that do not match are excluded. In some cases, users may be looking for a particular product without one or more particular attributes such as a specific color for example. In some other cases, certain attributes associated with products may be mistakenly recorded, labeled or missing in recorded product metadata, which may cause incorrect search results. To address these issues, there are needs to provide services that allow users to quickly find right items based on various search criteria while improving product metadata accuracy in an information management environment.

### SUMMARY

In accordance with some embodiments of the present disclosure, there is provided a method implemented by a computing system of performing concepts disclosed herein. The computing system includes one or more processors and one or more computer-readable storage devices storing computer-executable computer instructions. The method includes executing the instructions to cause the computing system to perform operations including: storing, in a database, a plurality of datasets associated with a plurality of items, each dataset being associated with an item and item metadata and comprising at least one of an attribute, an item name, a bar code and an item image; presenting a graphical user interface (GUI) on a first user device operated by a first user, the GUI comprising an item search box and a set of attribute-based filters, the set of attribute-based filters being associated with a predefined attribute and comprising a negative filter, a positive filter, and a default filter; receiving, from the first user device, a first search request with a first user input and a selection of the negative filter associated with the predefined attribute, the negative filter being configured to select one or more searched items without the predefined attribute recorded in respective datasets; and applying, based on the search request, the negative filter to search the database to present a first list of items each without the predefined attribute on the GUI of the first user device.

In accordance with some embodiments, there is provided a computer system configured according to the concepts and principles disclosed herein. The computer system includes one or more processors and one or more computer-readable storage devices storing computer-executable instructions. The instructions may be operable to cause the computing system to perform operations including: storing, in a database, a plurality of datasets associated with a plurality of items, each dataset being associated with an item and item metadata and comprising at least one of an attribute, an item name, a bar code and an item image; presenting a graphical user interface (GUI) on a first user device operated by a first user, the GUI comprising an item search box and a set of attribute-based filters, the set of attribute-based filters being associated with a predefined attribute and comprising a negative filter, a positive filter, and a default filter; receiving, from the first user device, a first search request with a first user input and a selection of the negative filter associated with the predefined attribute, the negative filter being configured to select one or more searched items without the predefined attribute recorded in respective datasets; and applying, based on the search request, the negative filter to search the database to present a first list of items each without the predefined attribute on the GUI of the first user device.

It is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 illustrates a hardware structure of an exemplary system in accordance with some embodiments of the present disclosure.

FIG. 2 is a flowchart illustrating an example process configured to apply negative filters and related control objects to improve product metadata in accordance with some embodiments of the present disclosure.

FIG. 3 is a flowchart illustrating an example process configured to apply positive filters related control objects to improve product metadata in accordance with some embodiments of the present disclosure.

FIG. 4 illustrates an example GUI including search result without applying an attribute-based filter on a search term to show in accordance with one embodiment of the present disclosure.

FIG. 5 illustrates an example GUI including search result by applying a negative filter on a search term in accordance with one embodiment of the present disclosure.

FIG. 6 illustrates an example GUI including search result by applying a negative filter and related controls on a search term in accordance with some embodiments of the present disclosure.

FIG. 7 illustrates an example GUI including search result by applying a positive filter on a search term in accordance with some embodiments of the present disclosure.

FIG. 8 illustrates an example GUI including search result by applying a positive filter and related controls on a search term in accordance with some embodiments of the present disclosure.

FIG. 9 is a flowchart illustrating an example process configured to scan and update product metadata in an information management environment in accordance with some embodiments of the present disclosure.

FIG. 10 illustrates an example GUI showing scanned results on a mobile device in accordance with some embodiments of the present disclosure.

FIG. 11 is a block diagram of an example computing device in accordance with some embodiments of the present disclosure.

### DETAILED DESCRIPTION

Embodiments of the present disclosure describe techniques of applying attribute-based filters and corresponding controls on searched visual representations to improve item metadata accuracy in an information management environment.

Building and maintaining item metadata for different attributes used for filtering search results is usually very time consuming and cumbersome with existing search engines or tools. There is a need for applying an efficient and effective service that allows customers to quickly find what they are looking for by setting up negative and positive filters to fulfill variety of attribute-based searching requirements while speeding up the ability of retail employees to maintain and correct item metadata in a visual fashion.

The embodiments address a computer-centric and Internet-centric problem associated with an online product searching and metadata management to facilitate in improving metadata accuracy and management efficiency within an information management environment.

Embodiments described herein are directed to a system and method to apply a negative filter during product search to find everything that does not match an attribute-based filter and to correct product metadata. For example, the customer may negate the search filter with a particular metadata attribute they do not like, and see all the items that are sold that does not have the predefined metadata attribute such as a particular color.

Embodiments of the present disclosure may dramatically speed up visual processes of item metadata generation, update and maintenance within an information management environment.

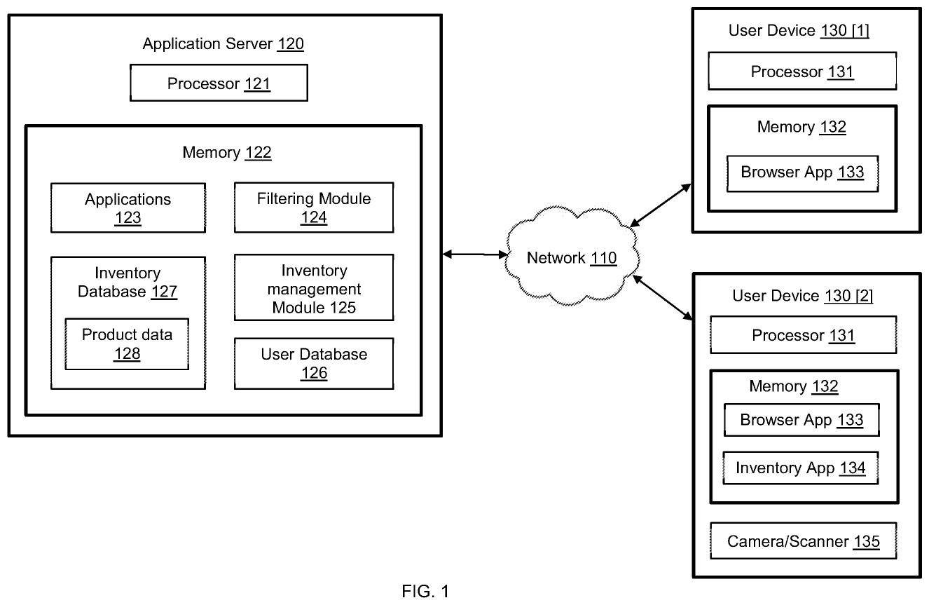

FIG. 1 illustrates a hardware structure of an example computing system 100 in a server-client computing environment according to some embodiments of the present disclosure. System 100 may include an application server 120 (e.g., a server computing device), one or more user devices 130 (e.g., client computing devices), and databases that may be communicatively connected to one another in a cloud-based or hosted environment by a network 110. Network 110 may include the Internet and/or other public or private networks or combinations thereof.

Application server 120 may include processor 121, memory 122 (e.g., a non-transitory machine-readable medium) and a communication interface for enabling communication over network 110 with a plurality of user devices, such as user device 130[1] and user device 130[2] illustrated in FIG. 1. Application server 120 may host an ecommerce web site for a retail merchant and corresponding ecommerce mobile applications that allow users to conduct online activities via user devices 130. Processor 121 is configured to execute instructions stored in memory 122 to process data and implement specific operations. Application server 120 may be a web server which include one or more applications 123 stored as computer-implemented instructions in memory 122.

Application server 120 may include filtering module 124 and inventory management module 125 for preforming product search and metadata management. Filtering module 124 and inventory management module 125 may be configured as computer programs (e.g., software) executed on one or more computers, in which the systems, models, algorithms, processes, and embodiments can be implemented as described below.

Application server 120 may include a user database 126 and an inventory database 127 which may be coupled to or in communication with application server 120 via network 110. Database 126 and database 127 may each be a shared remote database, a cloud database, or an on-site database. Database 126 and database 127 may receive instructions or data from and send data to application server 120 and store processing result via network 110. User database 126 may store the outcome of the processing by one or more application 123 and different modules of application server 120. Inventory database 127 may record, store or otherwise contain data associated with a plurality of items and/or services that are available at an ecommerce web site hosted on application server 120.

Inventory database 127 may store product data with a plurality of datasets associated with a plurality of items provided by a retailer for selling. Each dataset may include respective item metadata and one or more photos associated with each item. Item metadata may include a plurality of item attributes, such as item name, item description, a bar code, stock keeping unit (SKU) code, color, photo(s), features, material, price, size, brand, etc. Some item attributes such as color and size may be referred to as a facets and the facet may represent a class of attributes, such as a class of different colors. A group of products sharing the same name and description may have different attributes, such as color and size. The bar code associated with an item may be a universal product code (UPC) barcode and/or a quick response (QR) code, or other types of codes representing a product. A SKU code is referred to as a retailer code that may be used to track product, manufacturer, and price information. Each item (e.g., commercial product) may be represented by a barcode encoded in the item metadata.

User database 126 may store employee profiles and user profiles managed by one or more applications 123. For example, the database 126 may store employee profiles and each employee profile may be created for each employee and include an employee name, identifier, title, email, phone number, working location, etc. Each customer may create a user account with user information for purchasing one or more products available on the ecommerce web site hosted on the application server 120 or corresponding ecommerce mobile application managed by a retailer or merchant via network 110. Customer profile may include user information such as user name, user identifier (ID), email address, delivery address, phone number, payment transaction accounts, and any other user information.

User devices 130 may be any device configured to present user interfaces and receive user inputs thereto. For example, user device 130 may be a smartphone, personal computer, tablet, laptop computer, a personal digital assistant (PDA), mobile device, or other device. User device 130 can be used by a user, which also can be referred to a customer or a retail employee. User device 130 may include a processor 131, a memory 132 that includes instructions of a browser application 133 or other applications for execution by the processor 131 to cause user device 130 to perform specific tasks. For example, browser application 133 may be implemented as a web browser to provide a convenient graphical user interface to allow a user to browse information available over network 110. In some embodiments, browser application 133 may facilitate user interaction with one or more applications 123 running in application server 120 application server 120, transmit information to and receive information from application server 120 via network 110.

In some embodiments, the one or more applications 123 may be executed by processor 121 to allow a customer via a user device 130[1] to browse and/or search for products, to add products to an electronic shopping cart, to purchase products, as well as access and/or update user and product information or web content. Applications 123 may include a web application that can be accessed by a user device 130[1] via a browser application 133. Application server 120 may communicate with a plurality of user devices 130[1] via network 110 to present visual representation of web pages with information in response to users' inquiries or requests.

In some embodiments, user device 130[2] may be a handheld or wearable mobile device operated by a retail employee working in a warehouse or a distribution center. User device 130[2] may include camera/scanner 135 configured to be communicatively coupled to or embedded in user device 130[2] for scanning a bar code associated with a product or an item. User device 130[2] may include a browser application 133 and inventory management application 134 stored in the memory 132 or access an inventory management application 123 hosted on application server 120 via browser app 133 over network 110. A retail employee may operate user device 130[2] to interact with an inventory management application 134 executed to be displayed on a touch screen display of user device 130[2]. In response to interactions via a user device by a retail employee, the inventory management application 134 may be executed to scan bar codes associated with items, identify respective item barcodes, generate item metadata, store the scanned information and generated product metadata into product database 127, and present one or more scanned items and respective metadata associate with the one or more items on the touch screen display of user device 130[2]. Further, the inventory management application 134 may facilitate in determining correct items and updating stored item metadata based on item metadata previously stored in inventory database 127. If the scanned item is not found in inventory database 127, the inventory management application 134 may be configured to store scanned information and generated metadata of a new item into the inventory database 127. In some embodiments, a retail employee may use user device 130[2] to retrieve customers' pending orders via browser application 133 and confirm stocked products via the interactive touch screen of the user device[2] in communication with application server 120 via network 110.

The inventory management application 134 may be executed by processor 121 to allow a retail employee via a user device 130[2] to identify and organize products, and to assist in updating product metadata in a product inventory system. For example, the UPC code or unique QR code associated with a product may be read by user device 130[2] via camera/scanner 135.

Application server 120 may be depicted as a single device for ease of illustration, but those of ordinary skill in the art will appreciate that application server 120, and/or user device 130 may be embodied in different forms for different implementations. For example, application server 120 may include a plurality of servers in communication with each other through network 110. Alternatively, the operations performed by application server 120 may be performed on a single server. In another example, a plurality of user devices 130 may communicate with application server 120. A single user may have multiple user devices 130, and/or there may be multiple users each having their own user device(s) 130.

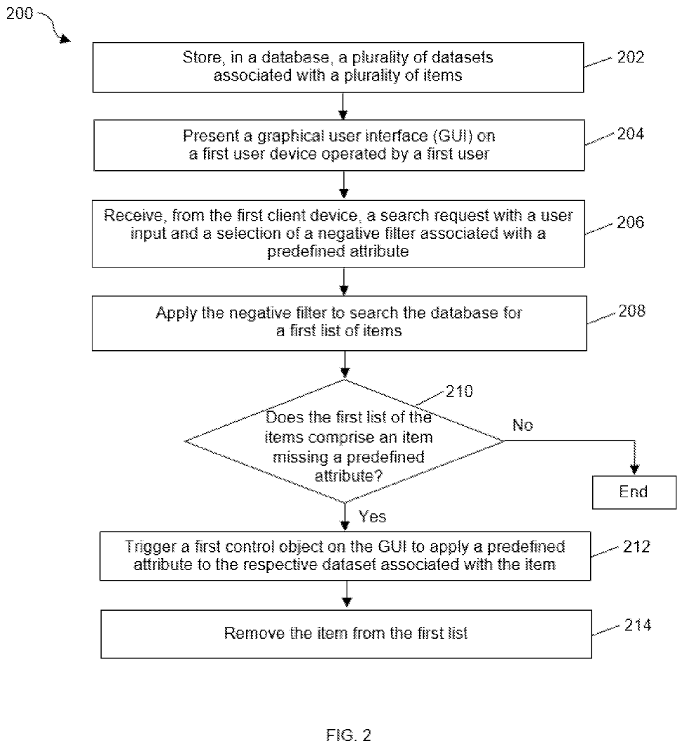

FIG. 2 is a flowchart illustrating an example process configured to apply negative filters and related control objects to improve product metadata in accordance with some embodiments of the present disclosure. The process 200 may be implemented in the computing system of FIG. 1 and configured as computer programs (e.g., software) executed on one or more computers, in which the systems, model components, processes, and embodiments described below can be implemented.

At step 202, application server 120 may store a plurality of item datasets associated with a plurality of items in an inventory database 127. Each item dataset may be associated with an item and item metadata and include at least one of an attribute, an item name, an item bar code and an item photo (e.g., item image) associated with an item. Each item dataset associated with an item may also include item description, SKU code, price, size, and brand, etc.

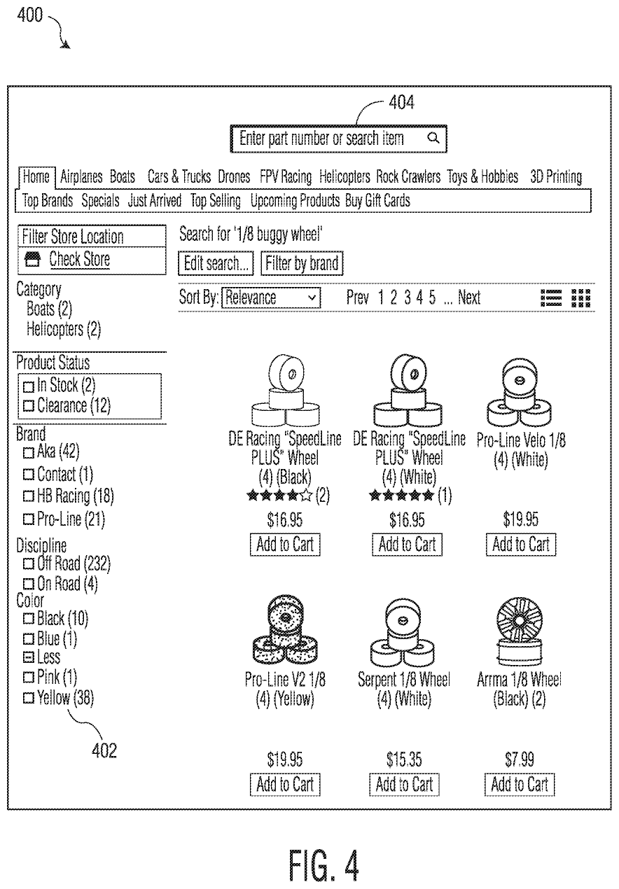

At step 204, a user may access an ecommerce web site hosted on application server 120 via browser app 133. Application server 120 may present a GUI on a user device 130. For example, FIG. 4 illustrates an example GUI 400 which shows products that match a search term in accordance with one embodiment. The GUI 400 of FIG. 4 may include an item search box 404 and a set of attribute-based filters. The search term may include product term, barcode, SKU code, color or other attributes. For example, the search result shown in FIG. 4 is provided by application server 102 without applying an attribute-based filter on a search term of “1/8 buggy wheel”.

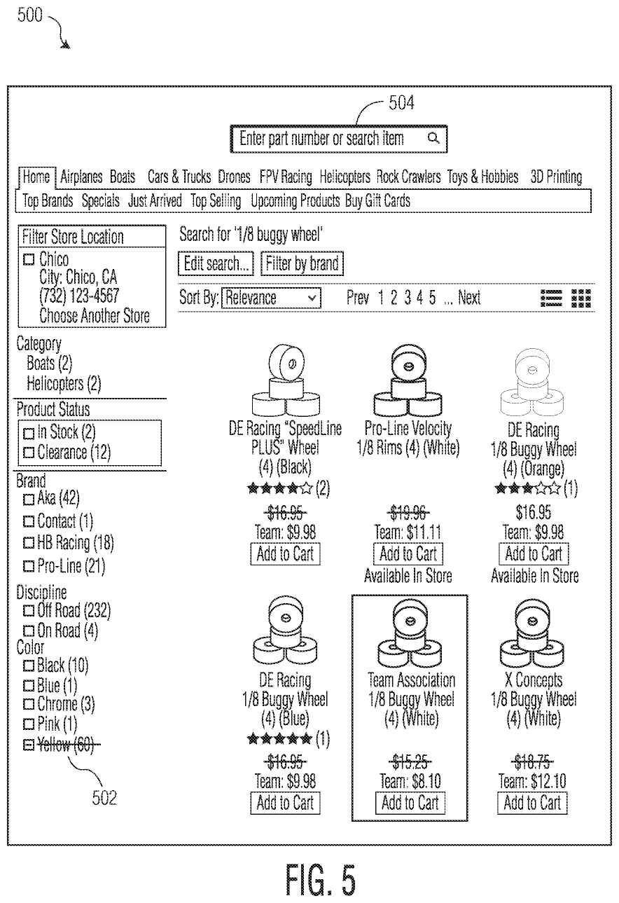

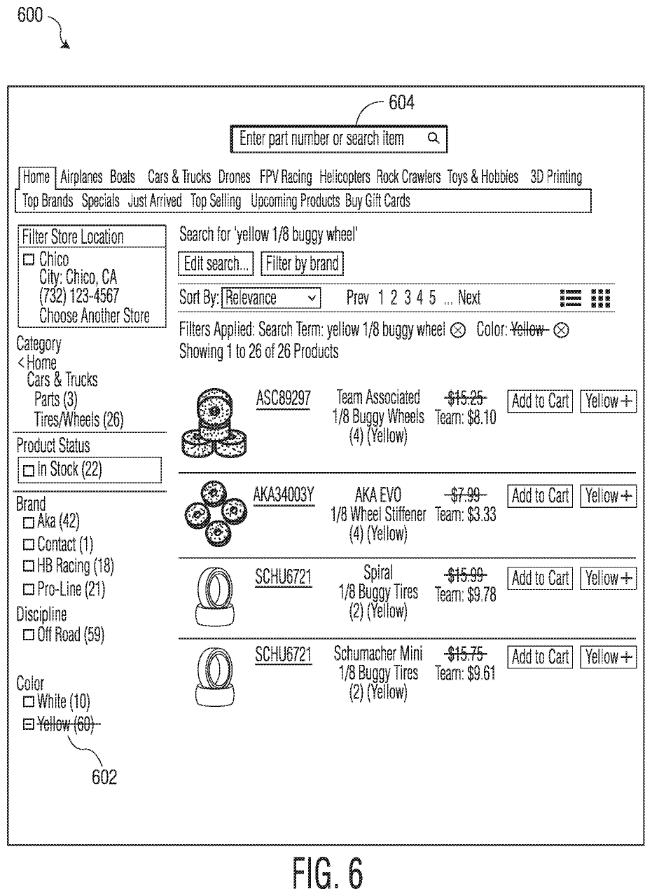

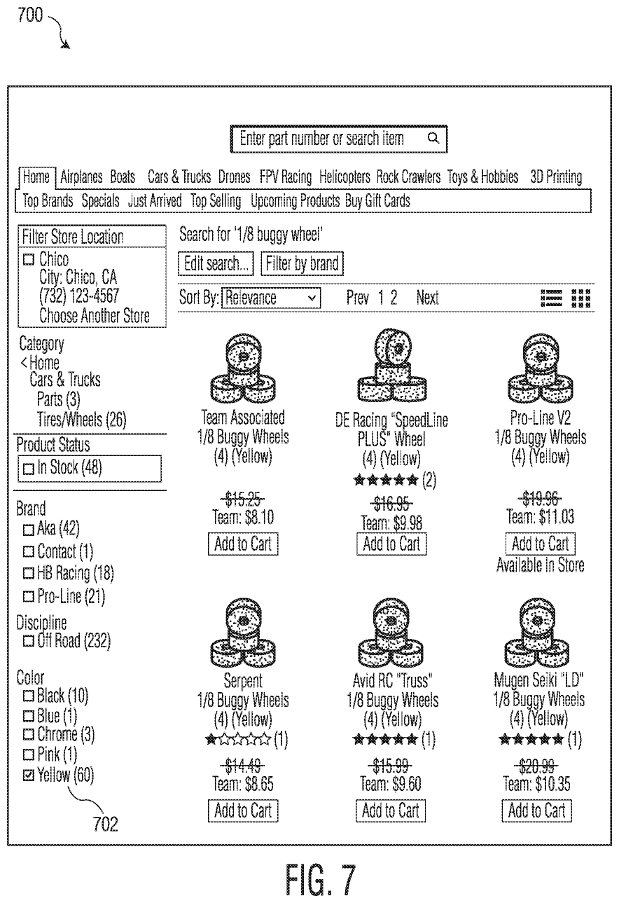

The set of attribute-based filters may be implemented by filtering module 124 of FIG. 1 and be configure to perform filtering functions associated with be associated with a metadata attribute (e.g., a yellow color). The set of attribute-based filters may include a default filter 502 of FIG. 5, a negative filter 602 of FIG. 6, and a positive filter 702 of FIG. 7. Each filter may be represented as a selectable user interface object configured to be triggered to implement a particular function. In one embodiment, the set of attribute-based filters may each be represented as a selectable user interface object displayed on the GUI and be configured to be triggered to function in a predetermined order. For example, the set of attribute-based filters may be implemented as a tri-state checkbox. A user interface checkbox 402 may be referred to as a default filter linked to the negative filter 602 or the positive filter 702 in response to respective user interactions. In response to user interactions on the user interface checkbox 402, the tri-state checkbox may activate the positive filter, when clicking it again, it may turned into a negative filter and be visually rendered to show respective search results. In one embodiment, the set of attribute-based filters may be represented as user interface objects displayed on the GUI simultaneously and be configured to be triggered to function respectively. For example, the set of attribute-based filters may be implemented as one control object represented as a slider on the GUI. In response to user interactions, the right side of the slide may be configured to active a positive filter and the left side of the slide may be configured to activate a negative filter. The slide control may allow the user to active either the positive filter or the negative filter with one click, rather than extra clicks on a tri-state checkbox.

At step 206, application server 120 may receive a search request from a user via a user device 130 for one or more items. The search request may include user inputs associated with item attributions. In some embodiments, the search request does not include a predefined attribute in respective item dataset or metadata. Application server 120 may receive user inputs entered to an item search box and a user selection of the negative filter from a set of attribute-based filters presented on the user interface of a user deceive 130. The search term may be one of item attributes, such as an item name, color, item SKU code, bar code, etc. For example, the search term may be “1/8 buggy wheel” shown in FIG. 5 or “yellow 1/8 buggy wheel” shown in FIG. 6 described below. The predefined attribute may be a yellow metadata attribute or a yellow color.

At step 208, in response to a user interaction on selecting the negative filter associated with the searched term, application server 120 may apply the negative filter on a predefined attribute to search inventory database 127 for related items. Application server 120 may present a first list of searched items without a predefined attribute on the user interface of the first user device 130. For example, FIG. 5 illustrates an example GUI 500 which present items that match the search term “1/8 buggy wheel” and each do not have a predefined yellow metadata attribute. All listed item are not yellow. In another example, FIG. 6 illustrates an example GUI 600 which show a list of items that match the search term “yellow 1/8 buggy wheel” and the negative filter 602. The negative filter 602 is configured to filter out items and each item does not have a yellow metadata attribute stored in respective item dataset and metadata. The example GUI 600 may show how the negative filter 602 for the yellow metadata attribute is applied in combination with a search term to find “yellow” in the product name. Application server 120 may determine and present one or two items on the top of the first list which shows “yellow” in the search term. As illustrated in the example GUI 600 of FIG. 6, the first list of searched items do not have a predefined attribute (e.g., yellow metadata attribute) associated with respective item dataset and metadata. The first two items in the first list of the searched items are actually shown as yellow items but they do not include or are missing a yellow metadata attribute in the respective dataset and metadata stored in inventory database 127, even though each respective item name may include the term of yellow.

At step 210, in response to determining that one or more items in the first list of the searched items are missing a predefined attribute in the respective metadata, the application server 120 may present a control object 606 on the GUI 600 for applying the yellow metadata attribute to each respective metadata or the described one or more items. The control object 606 may be configured to be triggered by a user selection to add the predefined attribute to the respective metadata. For example, application server may receive a user interaction of triggering the control object 606 which is indicated as a “Yellow +” button presented on the right side of the GUI 700 for applying the yellow metadata attribute to the first two items in the first list.

At step 214, application server 120 may remove the one or more items updated with the yellow metadata attribute from the first list displayed on the GUI.

The described embodiments in process 200 may be utilized in an information management environment to allow users to apply a negative filter with a predefined attribute during product search to find one or more items that do not have a predefined attribute stored in respective item metadata in a database. The described in process 200 may be utilized in determining and displaying items missing the predefined attribute in related item metadata stored in the database. The described in process 200 may allow retail employee to receive an user interaction of triggering a first control object presented on the GUI for adding the predefined attribute to the respective dataset associated with the item via a visual presentation. The described embodiments may refine the search results by color, usage or some other interesting feature.

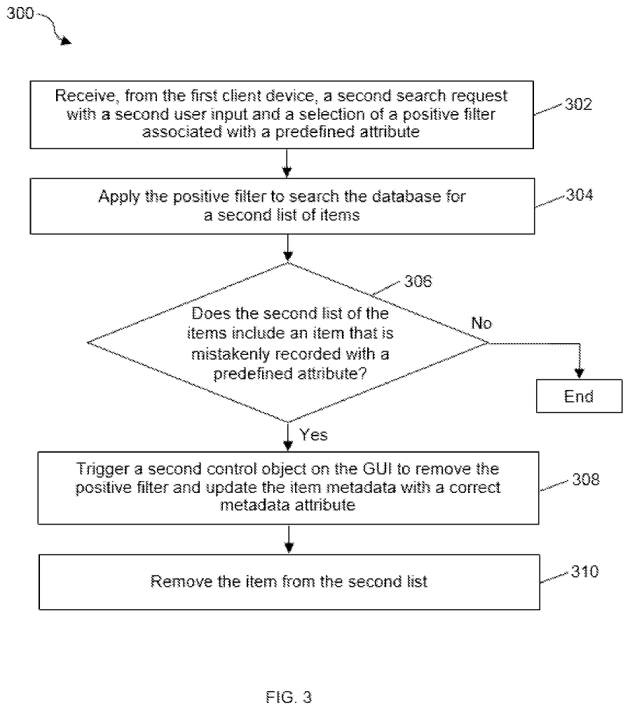

FIG. 3 is a flowchart illustrating an example process configured to apply a positive filter and a related control object to improve product metadata in accordance with some embodiments of the present disclosure. The process 300 may be implemented in the computing system of FIG. 1 and configured as computer programs (e.g., software) executed on one or more computers, in which the systems, model components, processes, and embodiments described below can be implemented.

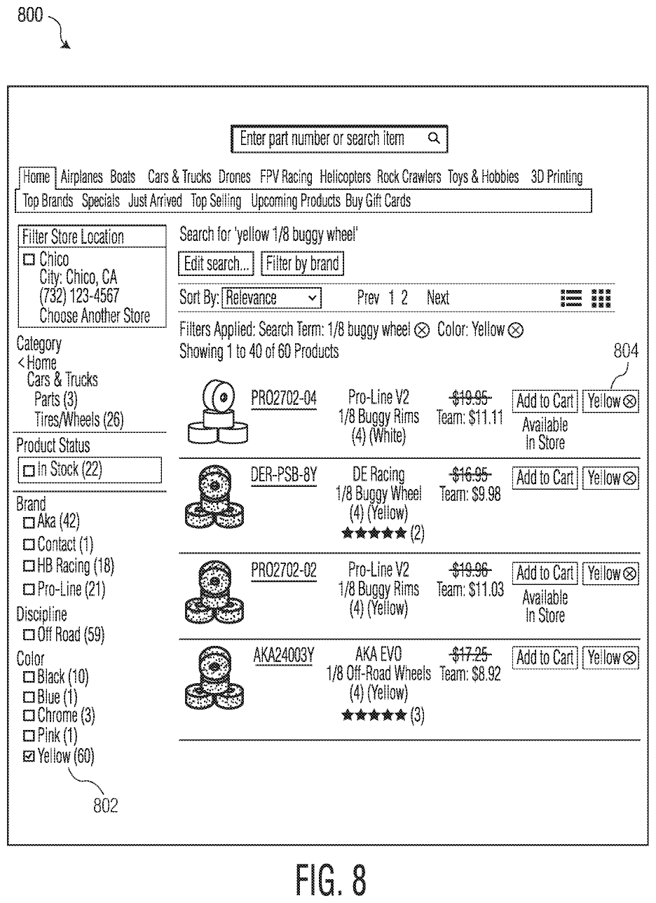

FIG. 8 illustrates an example GUI 800 which is configured to apply a positive filter 802 to shows items that match the search term “1/8 buggy wheel”. A positive filter 802 may be applied by application server 120 to search the inventory database 127 for one or more items each having a predefined metadata attribute such as a yellow color. As shown in FIG. 8, the first item in the second list is actually a white wheel and is mistakenly recorded with yellow metadata attribute stored in the inventory database 127.

At step 302, application server 120 may receive a second search request from a user device 130 for one or more items which include a predefined attribute (e.g., yellow metadata attribute). Application server 120 may receive user inputs such as “1/8 buggy wheel” and a user selection of the positive filter 802 via a user deceive.

At step 304, in response to a user interaction on applying the positive filter 802 associated with a predefined attribute on the searched term, application server 120 may apply the positive filter 802 to search the inventory database 127 and present a second list of searched items on the GUI 800 of the first user device 130. The positive filter 802 is configured to present a plurality of items with a predefined attribute (e.g., yellow metadata attribute). For example, FIG. 8 illustrates an example GUI 800 which show a plurality of items that match the search term “1/8 buggy wheel” and have a yellow metadata attribute based on the respective stored datasets or item metadata.

At step 306, application server 120 may determine whether the second list of the searched items comprise one or more items that each do not have a predefined attribute. The application server 120 may sort the searched items and present the one or more items without the predefined attribute on the top of the second list. For example, as illustrated in FIG. 8, an example GUI 800 shows that the positive filter 802 for the color yellow is applied in combination with a search term to find items which are not yellow in the product name but is mistakenly recorded with the predefined attribute. After the positive filter 802 for the color yellow is applied in combination with a search term in FIG. 8, the first item in the second list is shown as a white item on the top of the second list based on the item image color. The search result shows that the dataset associated with the first item in the second list may have a yellow metadata attribute mistakenly stored in inventory database 127. However, the first item in the second list has an image color shown as white even though the respective item name of each item may include the term of yellow.

At step 308, a control object 804 may be configured to be presented on the GUI 800. In response to a user interaction on the control object 804, application server 120 may remove a yellow metadata attribute of the first item in the second list with a corresponding correct metadata attribute (e.g., a color of “White”). For example, a retail employee may select and trigger a control object 804 displayed on the GUI 800 to remove the positive filter such that yellow metadata attribute of the first item is updated with a white color and stored in inventory database 127.

At step 310, in response to determining that an item of the second list of the items is mistakenly recorded with a predefined attribute (e.g., yellow metadata attribute), a control object 804 may be configured to be presented on the GUI to remove the yellow metadata attribute from the first item in the second list. A user may select and trigger a control object 804 displayed on the GUI 800 to remove and update a yellow metadata attribute from the respective dataset associated with the item. For example, the user may click the control object 804 which is “Yellow X” button presented on the right side of the GUI 800 to remove the yellow metadata attribute from the related items.

The described embodiments in process 300 may be utilized in an information management environment to allow users to apply a positive filter with a predefined attribute during product search to find items that include a predefined attribute stored in respective item metadata in a database. Further, the embodiments in process 300 may be utilized in determining and displaying items mistakenly recorded with the predefined attribute in related item metadata stored in the database and allow retail employee to receive an user interaction of triggering a second control object presented on the GUI for removing corresponding mistakenly recorded attribute from the respective dataset associated with the item via a visual presentation.

The method described in process 300 may dramatically speed up the ability of copywriting employees to edit, maintain, and fix product metadata in a visual fashion. For example, the copywriting department may forget to add all the necessary metadata and the related filters do not work very well. the described embodiments in process 300 may allow the copywriting employees to quickly identify the products that are missing filters, or those that have them incorrectly applied, and correct them by removing and updating related attributes or other attribute-based data for searched products via the user devices.

In some embodiments, metadata associated with items may be updated when corresponding items are processed both at the receiving and order picking stages at a distribution center or a retail warehouse. Item metadata may be updated when an item is in stocked into the inventory or sold to be removed from the inventory. For example, a retail employee may operate a user device such as a handheld or wearable mobile device 130[2] with a camera/scanner 135. The user device 130[2] may be configured to be communicatively coupled to or embedded in user device 130[2] for scanning a bar code associated with a product. Inventory management application 134 may be executed to be displayed on a touch screen display of user device 130[2] and to scan bar codes associated with products. Inventory management application 134 may be executed to identify respective barcodes, store the scanned information into inventory database 127, and present one or more scanned items and respective metadata associate with the one or more items on the touch screen display of user device 130[2]. Further, inventory management application 134 may facilitate in determining correct items and updating stored item metadata based on item metadata previously stored in inventory database 127. If the scanned item is not found in inventory database 127, inventory management application 134 may be configured to add a new item with respective metadata. In some embodiments, a retail employee may use user device 130[2] to retrieve customers' pending orders via browser application 133 and confirm stocked products via an interactive touch screen of the user device[2] in communication with application server 120 via network 110.

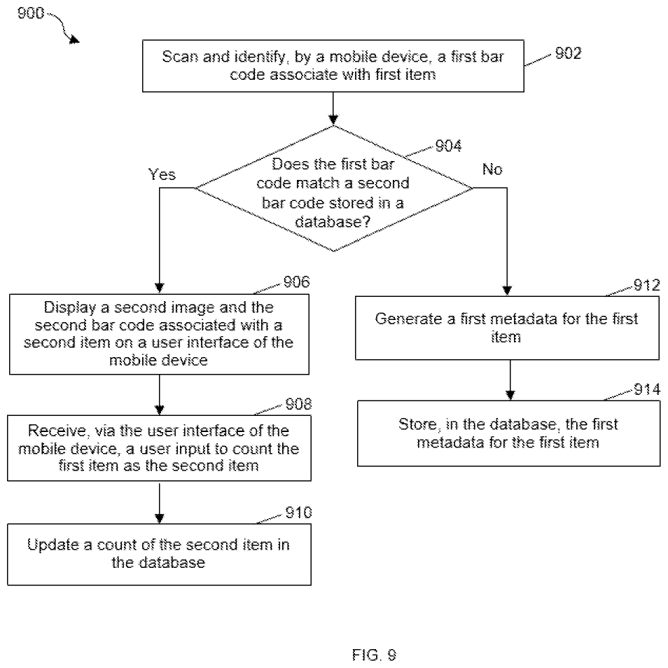

FIG. 9 is a flowchart illustrating an example process 900 configured to scan and update product metadata in an information management environment such as a distribution center or a warehouse in accordance with some embodiments of the present disclosure. The process 900 may be implemented in the computing system of FIG. 1 and configured as computer programs (e.g., software) executed on one or more computers, in which the systems, model components, processes, and embodiments described below can be implemented.

At step 902, user device 130[2] may be operated by a retail employee to scan a first bar code associate with first item. The first bar code may be identified by an inventory management application 134 which is communication with application server 120. Inventory management application 134 may be executed to generate a first image and identify respective barcode of the first item. Inventory management application 134 may store the scanned information into an inventory database 127 and present one or more scanned items and respective metadata associate with the one or more items of an order on the touch screen display of user device 130[2].

At step 904, application server 120 may search the inventory database 127 to determine whether the first bar code matches a second bar code associated with a second item and corresponding item metadata stored in inventory database 127.

At step 906, in response to determining that the first bar code matches a second bar code stored in the inventory database 127, the inventory management application 134 may be executed to present or display a second image and the second bar code associated with a second item on a user interface of user device 130[2].

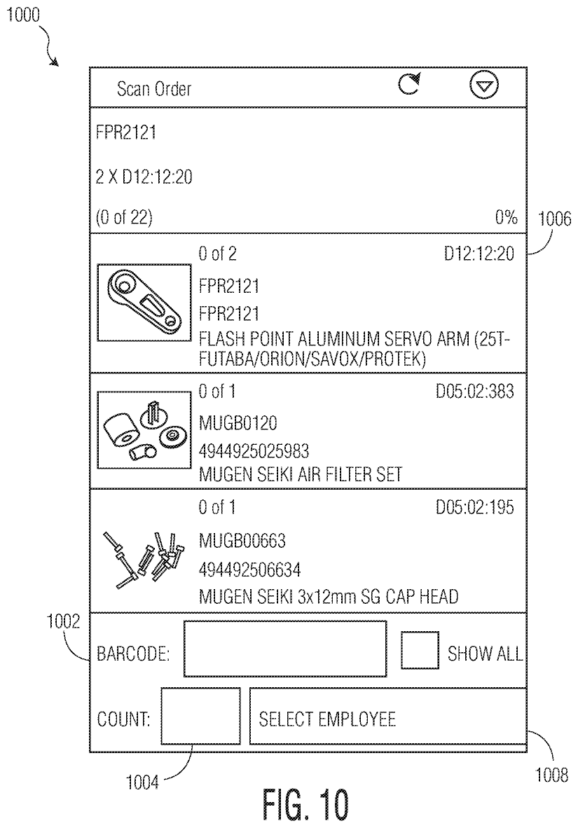

FIG. 10 illustrates an example GUI 1000 showing a visual representation of the items of an order presented to the pickers. GUI 1000 includes one or more graphical elements 1002-1008. Upon scanning an order with user device 130[2], the user may be presented with GUI 1000. GUI 1000 may include one or more graphical representations of each item of the scanned order. For example, as illustrated, GUI 1000 may include one or more graphical elements 1006. Each graphical element 1006 may illustrate a specific item of the scanned order. As shown, the order would include: 2 units of Flash Point Aluminum Servo Arm, 1 unit of Mugen Seiki Air Filter Set, and 1 item of Mugen Seiki 3×12 mm SG Cap Head. Each graphical element 1006 may help a user identify whether picked items match the displayed items of the order.

Graphical element 1002 of the GUI 1000 may correspond to a barcode of each scanned individual unit. For example, upon scanning a given Servo Arm, GUI 1000 may update and populate graphical element 1002 with the scanned barcode. The picker may identify whether any metadata attributes associated with a picked item match the displayed second item of the order. If metadata attributes associated with a picked item do not match the displayed second item of the order, the picked item may be a wrong product for the order. For example, item barcodes may be mis-assigned or the color of the picked item is wrong. The identified wrong item may be returned to the copywriting department or the warehouse for a further analysis.

Graphical element 1004 of the GUI 1000 may correspond to a count of units for a given item. For example, graphical element 1004 may be an editable count box and configured to allow a user (e.g., a picker/packer or a warehouse employee) to add a manual count via the user device 130[2] when scanning the items.

Graphical element 1008 of the GUI 1000 may correspond to a dropdown menu. For example, graphical element 1008 may correspond to a dropdown menu that allows a user to select an employee name from a list of employees. Graphical element 1008 may be used to determine which employee scanned the order. Graphical element 1008 may be set by default to an employee who currently logs in the inventory management application 134 and operates the user device 130[2]. Graphical element 1008 may be configured to change to a different employee if necessary. In one embodiment, item barcodes may be used to assign the order, rather than being picked from an item list of the order. For example, graphical element 1008 may be used to assign a picked order to a different user (e.g., an employee supervisor) to evaluate the correctness of the picked order. The order may be assigned back to an original employee who picked or packed it to ensure the statistics data is accurate as the accuracy of the corresponding picked order may reflect on the original employee's job performance.

At step 908, the second item may be counted by the user operating user device 130[2] and the corresponding count may be entered into and shown as graphical element 1004 of FIG. 10 on the user interface of user device 130[2]. The user device 130[2] may count all the items by scanning each item barcode individually, unless the total count is larger than a threshold value (e.g., 20 units). The count box 1004 may be hidden by default unless the actual number to scanned items is larger than the threshold value. For example, if a customer is purchasing 50 units or 100 units of items are received by the warehouse, a picker or warehouse employee may scan the barcode for each item of the order, visually verify and count a total number of items, then enter the total number of the items into the count box 1004.

At step 910, a count of the second item may be updated and stored in inventory database 127 via the GUI presented by executing the inventory management application 134 on user device 130[2].

At step 912, in response to determining that the first bar code is not found in the database or does not match any bar cords stored in inventory database 127, the scanned item may be a new item or a wrong item. The scanned item may be returned to the copywriting department or the warehouse for further analysis. The copywriting department or the warehouse may generate a first metadata for the first item. The first metadata may be a new metadata or updated metadata associated with the first item. The first metadata may include a product name, product ID, product photo, and product location, numbers of in stocked products associated with the first item.

At step 914, the generated first metadata associated with the first item may be stored in inventory database 127.

The method described in process 900 may dramatically improve accuracy of picking products from a distribution center by including photos along with product names to allow pickers to visually identify the products. The described embodiments in process 900 may facilitate in quickly identifying the products having incorrect barcodes or other attributed-based information. For example, the described embodiments may quickly identify products that had barcodes applied when they arrived, that accidentally had the wrong barcode.

The method described in process 900 may be deployed at both the product receiving stage and order picking stages of the distribution center with an improved accuracy for receiving product and order picking, resulting in improved customer satisfaction.

Embodiments described herein may be implemented in the system 100 of FIG. 1 and utilized in an information management environment for generating product metadata for new items and improving product metadata accuracy for product metadata stored in a database, thereby improving user experience in searching products and maintaining product metadata.

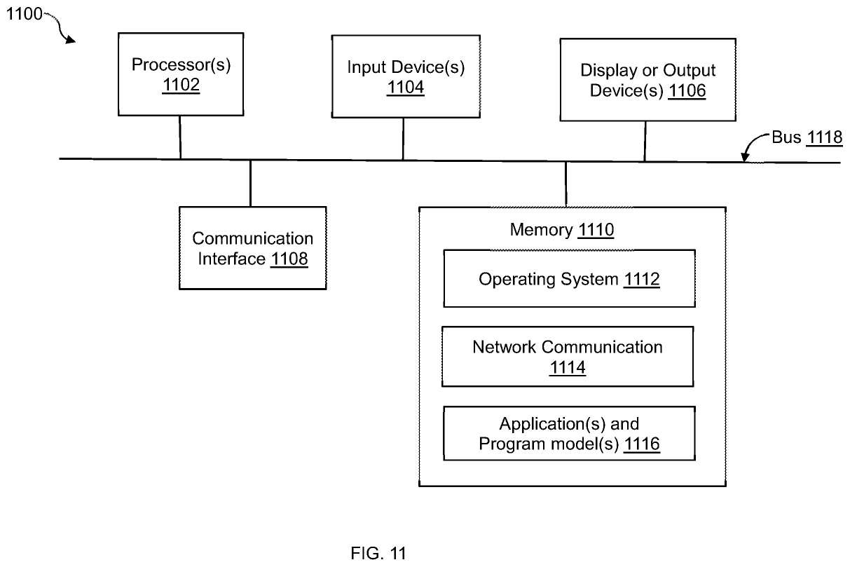

FIG. 11 is a block diagram of an example computing device 1100 that may be utilized to execute embodiments to implement processes including various features and functional operations as described herein. For example, computing device 1100 may function as workflow server 102, user/client devices 104 or a portion or combination thereof in some embodiments. The computing device 1100 may be implemented on any electronic device to execute software applications derived from program instructions, and may include but is not limited to personal computers, servers, smart phones, media players, electronic tablets, game consoles, email devices, etc. In some implementations, the computing device 1100 may include one or more processors 1002, one or more input devices 1104, one or more display or output devices 1106, one or more communication interfaces 1108, and memory 1110. Each of these components may be coupled by bus 1118, or in the case of distributed computer systems, one or more of these components may be located remotely and accessed via a network.

Processor(s) 1102 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Input device 1004 may be any known input device technology, including but not limited to a keyboard (including a virtual keyboard), mouse, track ball, and touch-sensitive pad or display. To provide for interaction with a user, the features and functional operations described in the disclosed embodiments may be implemented on a computer having a display device 1306 such as a CRT (cathode ray tube) or LCD (liquid crystal display) monitor for displaying information to the user and a keyboard and a pointing device such as a mouse or a trackball by which the user can provide input to the computer. Display device 1106 may be any known display technology, including but not limited to display devices using Liquid Crystal Display (LCD) or Light Emitting Diode (LED) technology.

Communication interfaces 1008 may be configured to enable computing device 1100 to communicate with other another computing or network device across a network, such as via a wired connection, a wireless connection, or a combination of wired and wireless connections. For example, communication interfaces 1108 may include an Ethernet interface, an optical interface, a coaxial interface, an infrared interface, a radio frequency (RF) interface, a universal serial bus (USB) interface, a Wi-Fi interface, a cellular network interface, or the like.

Memory 1110 may be any computer-readable medium that participates in providing computer program instructions and data to processor(s) 1102 for execution, including without limitation, non-volatile storage media (e.g., optical disks, magnetic disks, flash drives, etc.), or volatile storage media (e.g., SDRAM, ROM, etc.). Memory 1110 may include various non-transitory computer-readable instructions for implementing an operating system 1112 (e.g., Mac OS®, Windows®, Linux), network communication 1114, and Application(s) and program modules 1116, etc. The operating system may be multi-user, multiprocessing, multitasking, multithreading, real-time, and the like. The operating system may perform basic tasks, including but not limited to: recognizing input from input device 1104; sending output to display device 1106; keeping track of files and directories on memory 1110; controlling peripheral devices (e.g., disk drives, printers, etc.) which can be controlled directly or through an I/O controller; and managing traffic on bus 1118. Bus 1118 may be any known internal or external bus technology, including but not limited to ISA, EISA, PCI, PCI Express, NuBus, USB, Serial ATA or FireWire.

Network communications instructions 1014 may establish and maintain network connections (e.g., software applications for implementing communication protocols, such as TCP/IP, HTTP, Ethernet, telephony, etc.).

Application(s) and program modules 1116 may include software application(s) and different functional program modules which are executed by processor(s) 1102 to implement the processes described herein and/or other processes. The program modules may include but not limited to software programs, objects, components, data structures that are configured to perform particular tasks or implement particular data types. The processes described herein may also be implemented in operating system 1112.

Communication between various network and computing devices may be facilitated by one or more application programming interfaces (APIs). APIs of system 1100 may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system that includes a back-end component, such as a data server, or that includes a middleware component, such as an application server or an Internet server, or that includes a front-end component, such as a user computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user or client computing devices and workflow server. A user or client computing device and server may generally be remote from each other and may typically interact through a network. The relationship of client computing devices and server may arise by virtue of computer programs running on the respective computers and having a client-server relationship to each other.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method implemented by a computing system, the computing system comprising one or more processors and one or more computer-readable storage devices storing computer-executable computer instructions, the method comprising executing the instructions thereby causing the computing system to perform operations comprising:
storing, in a database, a plurality of datasets associated with a plurality of items, each dataset being associated with an item and item metadata and comprising at least one of an attribute, an item name, a bar code and an item image;
presenting a graphical user interface (GUI) on a first user device operated by a first user, the GUI comprising an item search box and a set of attribute-based filters, the set of attribute-based filters being associated with a predefined attribute and comprising a negative filter, a positive filter, and a default filter;
receiving, from the first user device, a first search request with a first user input and a selection of the negative filter associated with the predefined attribute, the negative filter being configured to select one or more searched items without the predefined attribute recorded in respective datasets; and
applying, based on the search request, the negative filter to search the database to present a first list of items each without the predefined attribute on the GUI of the first user device.

2. The method of claim 1, wherein the instructions are further operable to cause the one or more processors to perform:
determining whether the first list of the items comprises an item missing the predefined attribute in the database;
in response to determining that the item in the first list of the items is missing the predefined attribute in the database, receiving an user interaction of triggering a first control object presented on the GUI for adding the predefined attribute to the respective dataset associated with the item; and
removing the item from the first list of the items displayed on the GUI.

3. The method of claim 1, wherein the instructions are further operable to cause the one or more processors to perform:
receiving, from the client device, a second search request with a second user input and a selection of the positive filter, the positive filter being configured to select one or more searched items each having the predefined attribute stored in respective datasets; and
applying, based on the second search request, the positive filter to search the database and present a second list of items each with the predefined attribute on the GUI of the first user device.

4. The method of claim 3, wherein the instructions are further operable to cause the one or more processors to perform:
determining whether the second list of the items comprises an item mistakenly recorded with the predefined attribute; and
in response to determining that an item of the second list of the items is mistakenly recorded with the predefined attribute, triggering a second control object displayed on the GUI to update the predefined attribute stored in the respective dataset associate with the item with a corresponding correct attribute; and
removing the item from the second list of the items displayed on the GUI.

5. The method of claim 1, wherein the set of attribute-based filters are each represented as a selectable user interface object on the GUI and are configured to be triggered to function in a predetermined order.

6. The method of claim 1, wherein the set of attribute-based filters are represented as respective user interface objects on the GUI and are configured to be triggered to function respectively.

7. The method of claim 1, wherein the predefined attribute is a type of color.

8. The method of claim 6, wherein each dataset associated with the item further comprises description, stock keeping unit (SKU) code, price, size, and brand.

9. The method of claim 1, wherein the instructions are further operable to cause the one or more processors to perform:
scanning, by a mobile device comprising a processor and a camera, a first bar code associate with first item to identify the first bar code and generate a first image associated with the first item;
receiving, from the mobile device, a third search request comprising the first bar code associated with an item.

10. The method of claim 1, wherein the instructions are further operable to cause the one or more processors to perform:
determining whether the first bar code matches a second bar code stored in the database;
in response to determining that the first bar code matches the second bar code stored in the database, displaying a second image and the second bar code associated with a second item on a user interface of the mobile device;
receiving, via the user interface of the mobile device, a third user input to count the first item as the second item; and
updating a count of the second item in stock in the database.

11. The method of claim 10, wherein the instructions are further operable to cause the one or more processors to perform:
in response to determining that the first bar code is not included in the database, generating a first metadata for the first item; and
storing, in the database, the first metadata and the first image for the first item.

12. A computing system, comprising:
one or more processors; and
one or more computer-readable storage devices storing computer-executable instructions, the instructions operable to cause the computing system to perform operations comprising:
storing, in a database, a plurality of datasets associated with a plurality of items, each dataset being associated with an item and item metadata and comprising at least one of an attribute, an item name, a bar code and an item image;
presenting a graphical user interface (GUI) on a first user device operated by a first user, the GUI comprising an item search box and a set of attribute-based filters, the set of attribute-based filters being associated with a predefined attribute and comprising a negative filter, a positive filter, and a default filter;
receiving, from the first user device, a first search request with a first user input and a selection of the negative filter associated with the predefined attribute, the negative filter being configured to select one or more searched items without the predefined attribute recorded in respective datasets; and
applying, based on the search request, the negative filter to search the database to present a first list of items each without the predefined attribute on the GUI of the first user device.

13. The system of claim 12, wherein the instructions are further operable to cause the one or more processors to perform:
determining whether the first list of the items comprises an item missing the predefined attribute in the database;
in response to determining that the item in the first list of the items is missing the predefined attribute in the database, receiving an user interaction of triggering a first control object presented on the GUI for adding the predefined attribute to the respective dataset associated with the item; and
removing the item from the first list of the items displayed on the GUI.

14. The system of claim 12, wherein the instructions are further operable to cause the one or more processors to perform:
receiving, from the client device, a second search request with a second user input and a selection of the positive filter, the positive filter being configured to select one or more searched items each having the predefined attribute stored in respective datasets; and
applying, based on the second search request, the positive filter to search the database and present a second list of items each with the predefined attribute on the GUI of the first user device.

15. The method of claim 14, wherein the instructions are further operable to cause the one or more processors to perform:
determining whether the second list of the items comprises an item mistakenly recorded with the predefined attribute; and
in response to determining that an item of the second list of the items is mistakenly recorded with the predefined attribute, triggering a second control object displayed on the GUI to update the predefined attribute stored in the respective dataset associate with the item with a corresponding correct attribute; and
removing the item from the second list of the items displayed on the GUI.

16. The system of claim 12, wherein the set of attribute-based filters are each represented as a selectable user interface object on the GUI and are configured to be triggered to function in a predetermined order.

17. The system of claim 12, wherein the set of attribute-based filters are represented as respective user interface objects on the GUI and are configured to be triggered to function respectively.

18. The system of claim 12, wherein the instructions are further operable to cause the one or more processors to perform:
scanning, by a mobile device comprising a processor and a camera, a first bar code associate with first item to identify the first bar code and generate a first image associated with the first item;
receiving, from the mobile device, a third search request comprising the first bar code associated with an item.

19. The system of claim 18, wherein the instructions are further operable to cause the one or more processors to perform:
determining whether the first bar code matches a second bar code stored in the database;
in response to determining that the first bar code matches the second bar code stored in the database, displaying a second image and the second bar code associated with a second item on a user interface of the mobile device;
receiving, via the user interface of the mobile device, a third user input to count the first item as the second item; and
updating a count of the second item in stock in the database.

20. The system of claim 19, wherein the instructions are further operable to cause the one or more processors to perform:
in response to determining that the first bar code is not included in the database, generating a first metadata for the first item; and
storing, in the database, the first metadata and the first image for the first item.
